(19) United States
(12) Patent Application Publication
(10) Pub. No.: US 2004/0141087 A1
(43) Pub. Date: Jul. 22, 2004

(54) Solid-state image pickup apparatus with influence of shading reduced and a method of controlling the same

(76) Inventors: Kazuya Oda, Asaka-shi (JP); Hirokazu Kobayashi, Asaka-shi (JP); Manabu Hyodo, Asaka-shi (JP)

Correspondence Address: BIRCH STEWART KOLASCH & BIRCH, PO BOX 747, FALLS CHURCH, VA, 22040-0747, US

(21) Appl. No.: 10/754,498

(22) Filed: Jan. 12, 2004

(30) Foreign Application Priority Data
Jan. 17, 2003 (JP) 2003-009778

(51) Int. Cl. H04N 5/225

(52) U.S. Cl. 348/340

(57) ABSTRACT

A method of controlling a solid-state image pickup apparatus with the step of determining the zoom position Z of a lens at the time of picking up an image. If the zoom position Z is above a lower value Z1 but below a higher value Z2, first color difference gain processing is executed. If the zoom position Z is below or equal to Z1, it is determined whether or not the photometric data A of a pixel block A used for divisional photometry is greater than a threshold TH. If the answer of this step is positive, second color gain processing is executed; otherwise, the first processing is executed. On the other hand, if the zoom position Z is above or equal to Z2 and if the photometric data B of a block B is greater than the threshold TH, the second color difference gain processing is executed; otherwise the first processing is executed.

### BACKGROUND OF THE INVENTION

1. Field of the Invention

The present invention relates to a method of controlling a solid-state image pickup apparatus configured to process and output an image signal output from a solid-state image sensor, which executes photoelectric transduction on an optical image representative of a field and focused thereon via a lens thereof. More specifically, the present invention relates to a method of controlling a solid-state image pickup apparatus in such a manner as to reduce the influence of shading particular to a solid-state image sensor of the type including a plurality of pixels which are arranged in a photosensitive array and each of which consists of a main and an auxiliary photosensitive cell, and a microlens positioned over the main and auxiliary photosensitive cells.

2. Description of the Background Art

It is a common practice with a solid-state image sensor to arrange microlenses on photosensitive cells, implemented by photodiodes, in order to increase the ratio of light incident to the individual photosensitive cells, thereby enhancing photoelectric transduction efficiency of the image sensor. The same assignee as that of the present patent application has proposed a solid-state image sensor having main and auxiliary photosensitive portions arranged in rows and columns in the photosensitive area formed on a semiconductor substrate for the purpose of further enhancing the resolution of an image signal, as disclosed in Japanese patent application No. 2002-16835, now laid open by publication No. 2003-218343.

Conventional solid-state image sensors have some problems left unsolved, as will be described hereinafter. A light beam incident to the photosensitive array of an image sensor via a lens includes not only light incident perpendicularly to the photosensitive array but also many light components incident obliquely to the array. Therefore, a circle of confusion, for example, formed by light via a microlens is not always formed at the center of a pixel facing the microlens, but is sometimes shifted from the center, depending on the position of the pixel in the region of the photosensitive array.

In the above circumstance, even when a subject with uniform illumination is picked up, the quantity of incident light is smaller at cells arranged in the peripheral portion of the photosensitive array than at cells located at the central portion of the same, which adjoins the optical axis of the lens. As a result, shading or luminance shading is involved in an image signal output from the image sensor and degrades image quality. Shading refers to the irregular distribution of lightness dependent on the position of a pixel in the photosensitive array.

Further, assume a solid-state image sensor in which composite pixels, each consisting of a main and an auxiliary photosensitive portion or cell different in area and therefore sensitivity, are arranged in a photosensitive array. Then, the influence of shading is conspicuous in such an image sensor particularly when the quantity of light incident to each auxiliary photosensitive portion differs from one position to another in the photosensitive array. Particularly, when color filter segments for implementing a color image are positioned at the individual composite pixels, shading causes the levels of color components to differ from each other, bringing about color shift. Thus, the influence of shading must be reduced in order to achieve a high-quality image.

Moreover, when an exit pupil or an f-stop number varies due to a change in the focal distance of the lens, the angle of light incident to the photosensitive array varies accordingly to cause the condition of shading and that of color shift to vary.

U.S. Pat. No. 5,530,474 to Takei, for example, proposes to limit a gain control range color by color in accordance with the luminance level of a subject for the purpose of reducing excessive or short correction of white balance. However, this kind of scheme, as well as other conventional schemes, does not give consideration to the variation of the amount of shading that occurs color by color due to the incidence angle and circle of confusion of a light beam incident on the image sensor. Such a scheme therefore cannot reduce or obviate color shift ascribable to local shading.

Particularly, in the case of the image sensor having the composite pixels each consisting of the main and auxiliary photosensitive cells respectively having a larger and a smaller area, shading on the auxiliary photosensitive cells or low-sensitivity photosensitive portions noticeably varies in accordance with pickup conditions. Consequently, color shift, for example, is more conspicuous at the auxiliary photosensitive cells than at the main photosensitive cells.

### SUMMARY OF THE INVENTION

It is an object of the present invention to provide a method of controlling a solid-state image pickup apparatus in such a manner as to reduce shading and color shift.

A control method of the present invention is applied to a solid-state image pickup apparatus configured to process and output an image signal output from a solid-state image sensor that converts an optical image representative of a field and focused on the image sensor by a lens to the image signal. The image sensor includes a plurality of composite pixels which are arranged in a photosensitive array and each of which consists of a main and an auxiliary photosensitive cell different in sensitivity from each other and formed by a main and an auxiliary photosensitive portion, respectively. A plurality of microlenses are respectively positioned on the composite pixels for focusing incident light. A plurality of color filter segments are also respectively positioned on the composite pixels and arranged in a preselected pattern. The method includes a photometry step of executing photometry with the field, a signal processing step of processing the image signal, and a control step of switching the signal processing of the signal processing step in accordance with the result of photometry. In the signal processing step, color difference gain processing for the image signal is switched in accordance with the control of the control step to thereby lower the chroma of the image signal.

A solid-state image pickup apparatus to be controlled by the above method is also presented.

### BRIEF DESCRIPTION OF THE DRAWINGS

The objects and features of the present invention will become more apparent from consideration of the following detailed description taken in conjunction with the accompanying drawings in which:

FIG. 1 is a flowchart useful for understanding a specific operation of a corrector that forms part of a digital signal processor included in a solid-state image pickup apparatus embodying the present invention;

FIG. 2 is a schematic block diagram showing the digital signal processor;

FIG. 3 is a schematic block diagram showing the general construction of the image pickup apparatus of the illustrative embodiment implemented as a digital camera by way of example;

FIG. 4 is an enlarged view showing part of composite pixels located at the peripheral portion of a solid-state image sensor included in the illustrative embodiment;

FIG. 5 is a view similar to FIG. 4, showing circles of confusion formed on the peripheral composite pixels when a lens zooms to its near exit pupil;

FIG. 6 is a view similar to FIG. 4, showing circles of confusion formed on the peripheral composite pixels when the lens zooms to its far exit pupil;

FIG. 7 shows a specific picture with luminance shading ascribable to auxiliary photosensitive portions each forming part of the individual composite pixel;

FIG. 8 is an enlarged view showing circles of confusion formed in another specific arrangement of the image sensor;

FIG. 9 shows a specific picture with luminance shading ascribable to auxiliary photosensitive portions included in the arrangement of FIG. 8;

FIG. 10 shows specific blocks constituting a frame and used for divisional photometry;

FIG. 11 is a graph plotting usual, color difference gain processing A unique to the illustrative embodiment; and

FIG. 12 is a graph plotting color difference gain processing B also unique to the illustrative embodiment.

### DESCRIPTION OF THE PREFERRED EMBODIMENT

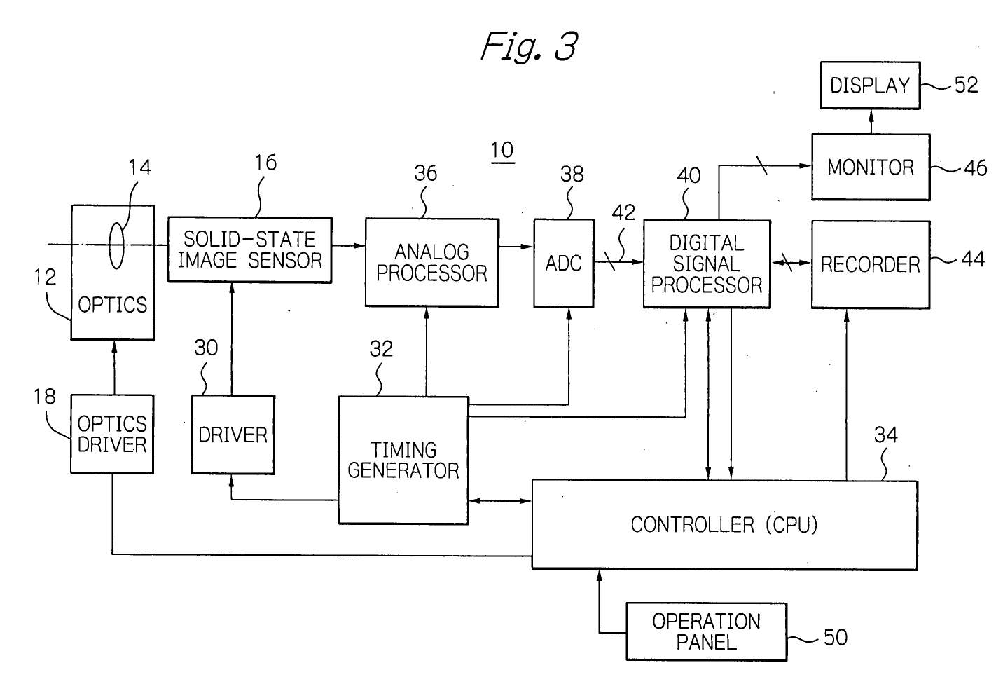

Referring first to FIG. 3 of the drawings, a solid-state image pickup apparatus embodying the present invention is implemented as a digital camera by way of example. As shown, the digital camera, generally 10, includes optics 12 and a solid-state image sensor 16. While a lens 14, included in the optics 12, focuses an optical image on the image sensor 16, the image sensor 16 generates an image signal representative of the optical image. In the illustrative embodiment, the lens 14 is implemented as a zoom lens whose focal distance is variable. Alternatively, use may be made of a single interchangeable lens removably mounted to the camera 10 and having a fixed focal distance.

The optics 12 includes, in addition to the lens 14, a mechanical shutter, an iris, and a mechanism for controlling the focus and focal distance of the lens 14, although not shown specifically. These constituents of the optics 12 other than the lens 14 each are driven by a particular drive signal output from an optics driver 18.

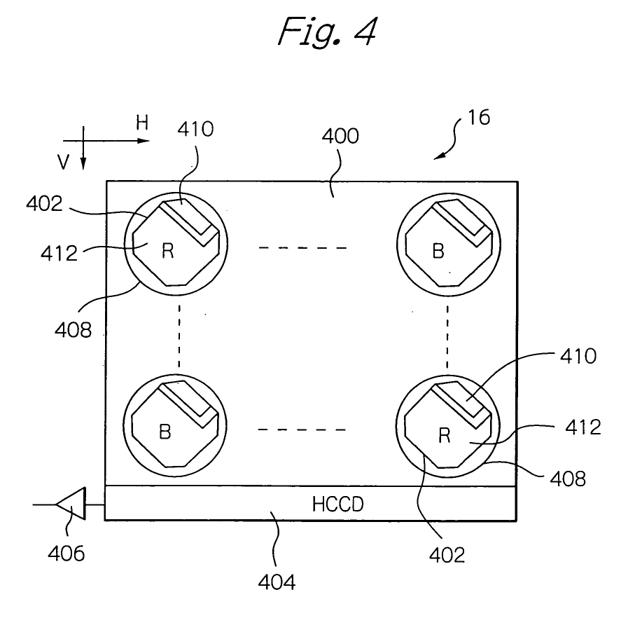

FIG. 4 shows a specific configuration of the solid-state image sensor 16 in a fragmentary view, as seen from a photosensitive array 400 side, while showing peripheral composite pixels in an enlarged scale. As shown, the image sensor 16, implemented by a CCD (Charge Coupled Device) image sensor by way of example, includes a plurality of composite pixels 402 shifted from each other by one-half of a pitch from each other in both of a horizontal scanning direction, H, and a vertical scanning direction, V. Vertical charge transfer paths, not shown, each extend zigzag between nearby arrays of composite pixels 402 in the vertical direction V and transfer signal charges generated by the composite pixels 402, which adjoin the left edge of the transfer path, in the direction V. A horizontal charge transfer path 404, implemented by HCCDs, transfers the above signal charges input thereto via the vertical charge transfer paths in the horizontal scanning direction H. The signal charges thus horizontally transferred are sequentially input to an output amplifier 406. The output amplifier 406 senses and amplifies the input signal charges to thereby output an image signal.

A plurality of convex microlenses 408 are also included in the image sensor 16, and each is positioned on particular one of the composite pixels 402. A filter is interposed between the microlenses 408 and the composite pixels 402 and has filter segments of primary colors or complementary colors arranged thereon in a preselected pattern. In the case of a primary-color filter, red (R), green (G) and blue (B) are arranged in, e.g. a G stripe, R/B full-checker pattern. It will thus be seen that the image sensor 16 has a honeycomb type pixel arrangement and a vertical transfer path configuration.

As shown in FIG. 4, the composite pixels 402, arranged in the photosensitive array 400 of the image sensor 16, each have an octagonal contour and are divided into a main and an auxiliary photosensitive portion or cell 412 and 410, respectively, by a generally L-shaped region obliquely in the up-and-down direction with respect to the horizontal scanning direction H. More specifically, the main photosensitive portion or region 412 forms a larger pixel having a relatively larger area and has a higher-sensitivity photoelectric transduction characteristic. The auxiliary photosensitive portion 410, positioned above and rightward of the main photosensitive portion 412, forms a smaller pixel having a relatively smaller area and has a lower-sensitivity photoelectric transduction characteristic.

The camera 10 of the illustrative embodiment uses one or both of signal charges derived from the main and auxiliary photosensitive portions 412 and 410 to generate an image signal representative of a moving picture or a still picture and, e.g. display or store an image represented by the above signal. The microlenses 408 each are fitted on the top of a particular composite pixel 402 and a particular color filter associated with the composite pixel 402. It is to be noted that FIG. 4 shows only part of the composite pixels 402, vertical charge transfer paths and microlenses 408 arranged in the photosensitive array 400 of the image sensor 16. In practice, several hundred thousands to several millions of composite pixels 402, for example, are arranged in the photosensitive array 400 as valid pixels.

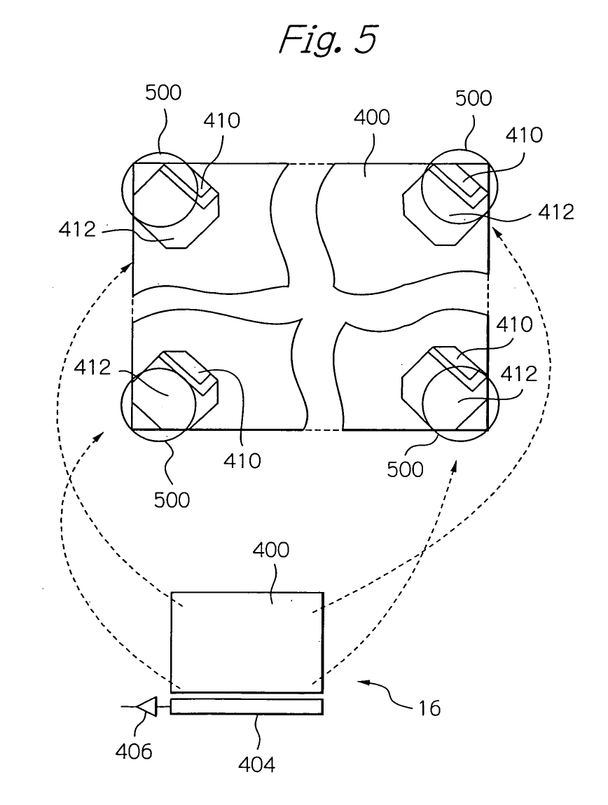

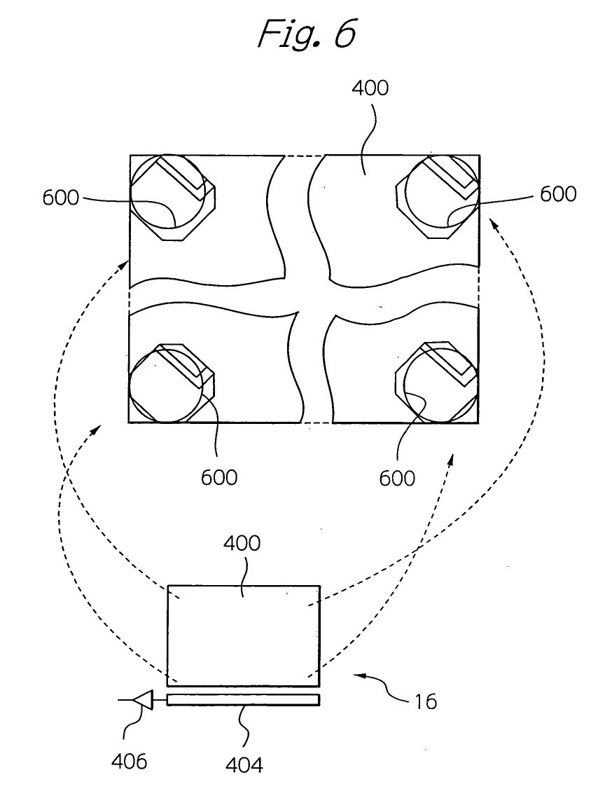

FIGS. 5 and 6 each show particular, specific circles of confusion formed by a light beam that is focused by the microlenses 408 in the photosensitive array 400. As shown in FIG. 5, when the lens 14 zooms to its near exit pupil, circles of confusion 500 on the composite pixels located at the peripheral portion of the photosensitive array 400 are noticeably shifted from the centers of the pixels outward away from the center of the photosensitive array 400. On the other hand, as shown in FIG. 6, when the lens 14 zooms to its far exist pupil, circles of confusion 600 are shifted less than the circles of confusion 500, FIG. 5. Consequently, in the condition shown in FIG. 5, in particular, the area of the auxiliary photosensitive portion 410 that the circle of confusion 500 overlaps greatly differs from the bottom left pixel to the top right pixel in the photosensitive array 400, so that a difference in luminance occurs for a given quantity of incident light and brings about color shift. To solve this problem, the illustrative embodiment estimates the degree of color shift to occur and executes processing for reducing it as part of signal processing, which will be described specifically later.

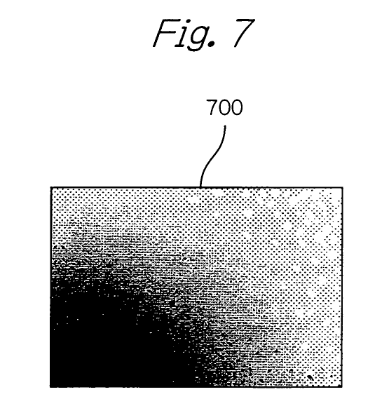

FIG. 7 shows a specific image 700 in which shading was brought about by the auxiliary photosensitive portions 410. As shown, underexposure occurs in the bottom left portion of the image 700 picked up, as presumed; the luminance level rises from the bottom left portion toward the top left portion of the image 700.

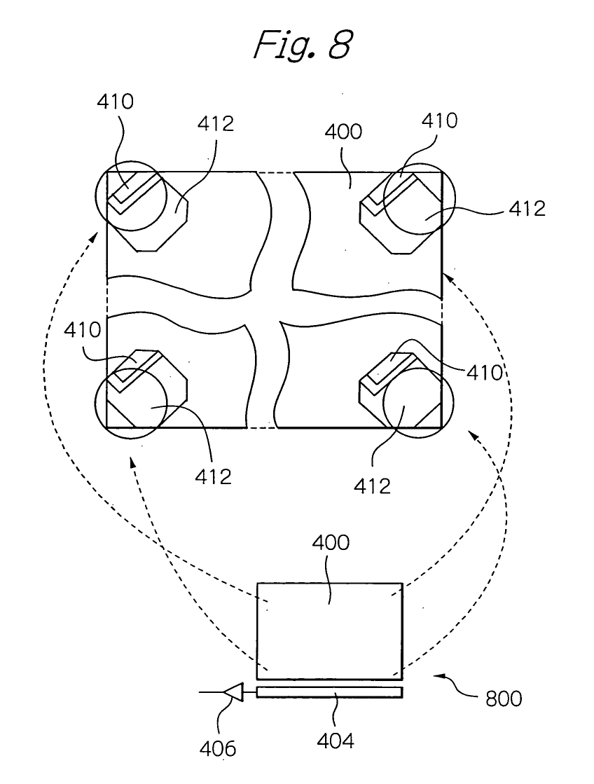

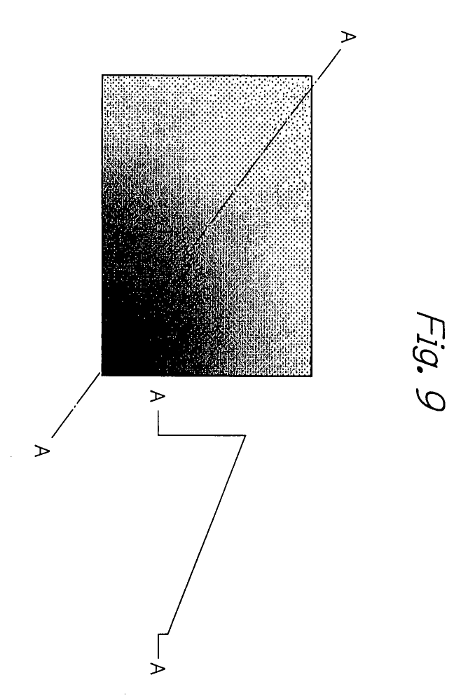

FIG. 8 shows another specific configuration of the solid-state image sensor. As shown, in this image sensor, labeled 800, the auxiliary photosensitive portion 410 of each composite pixel is positioned above and leftward of the main photosensitive portion 412. FIG. 9 shows a specific image picked up by the auxiliary photosensitive portions 410 each having the configuration of FIG. 8. As shown, underexposure occurs in the bottom right portion of the image. It will therefore be seen that the direction in which shading occurs varies in accordance with the positional relation between the main and the auxiliary photosensitive portions 412 and 410. Further, shading is dependent on the exit pupil position of the lens 14, iris configuration and other conditions established at the time of pickup.

In the illustrative embodiment, the image sensor 16 is capable of reading out signal charges generated in the auxiliary photosensitive portions 410 and signal charges generated in the main photosensitive portions 412 at different field timings, thereby reading out the auxiliary pixels from the auxiliary photosensitive portions 410 and the main pixels of the main photosensitive portions 412 separately. Also, in a camera mode or still picture mode available with the camera 10, the image sensor 16 is capable of reading out the auxiliary pixels from the auxiliary photosensitive portions 410 in the first field and then reading out the main pixels from the main photosensitive portions 412 in the second field to thereby complete a single frame of image.

Further, in a movie mode also available with the camera 10, the image sensor 16 is capable of outputting the auxiliary pixels of the auxiliary photosensitive portions 410 and the main pixels of the main photosensitive portions 412 while mixing them together. In this case, the image sensor 16 may be driven in such a manner as to thin, or reduce, the pixels in the vertical direction to, e.g. one-half or one-fourth by skipping the composite pixels at a preselected pitch corresponding to several pixels, thereby promoting high-speed signal charge transfer.

Referring again to FIG. 3, a driver 30 generates various drive signals, including horizontal and vertical transfer pulses, in accordance with a timing signal fed from a timing generator 32 and delivers the drive signals to the image sensor 16. More specifically, the driver 30 delivers particular drive signals to the image sensor 16 in each of the movie mode and camera mode.

The timing generator 32 generates various timing signals including a vertical drive timing signal, a horizontal drive timing signal, transfer gate pulses and a pixel clock. These timing signals are fed from the timing generator 32 to the driver 30, an analog processor 36, an ADC (Analog-to-Digital Converter) 38 and a digital signal processor 40 in accordance with a control signal fed from a controller 34, which is implemented by a CPU (Central Processing Unit).

In the movie mode, the driver 30 outputs drive signals that shift signal charges from the individual composite pixels 402 arranged in a vertical array to the vertical transfer path adjoining them while skipping, e.g. every other pixel 402, thereby forming a read-out line. The drive signals then cause the signals read out from the main and auxiliary photosensitive portions 412 and 410 of each composite pixel 402 to be mixed together on the vertical transfer path and then transferred via the vertical transfer path.

The driver 30 feeds shift pulses V1 through V4 to transfer electrodes V1 through V4, respectively during a vertical synchronizing time VD to thereby read out signal charges generated in the main and auxiliary photosensitive portions 412 and 410 to the vertical transfer paths. On the elapse of the vertical synchronizing time VD, the driver 30 feeds vertical transfer pulses V1 through V8 to transfer electrodes V1 through V8, respectively, for thereby reading out the pixels of the intermittent read-out lines at high speed.

On the other hand, in the camera mode, the driver 30 generates drive signals that readout, e.g. the auxiliary pixels of the auxiliary photosensitive portions 410 in the first field and then read out the main pixels from the main photosensitive portions 412 in the second field. The main and auxiliary pixels thus read out independently from each other are added to reconstruct the composite pixels by signal processing to follow, forming a single frame of picture having a broad dynamic range.

As shown in FIG. 3, the output of the image sensor 16 is connected to the analog processor 36. The analog processor 36 includes a CDS (Correlated Double Sampling) circuit, not shown, for canceling reset noise contained in the image signal input to the analog processor 36 and a GCA (Gain Controlled Amplifier), not shown, capable of varying the level of the image signal. The output of the analog processor 36 is connected to the ADC 38 configured to convert the image signal input thereto to digital values, i.e. image data.

The digital signal processor 40, connected to the output 42 of the ADC 38, stores the image data and performs calculation with the same under the control of the controller 34 to thereby output image data to be displayed and image data to be recorded. The image data to be recorded and the image data to be displayed are delivered to a recorder 44 and a monitor 46, respectively. The configuration and operation of the digital signal processor 40 will be described more specifically later.

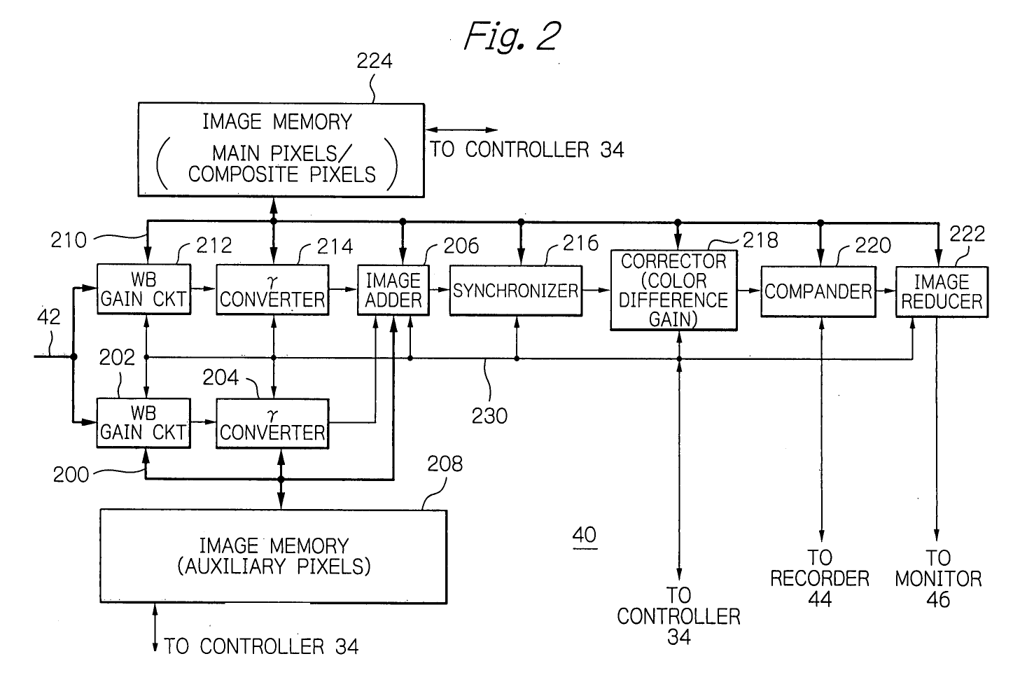

The controller or CPU 34 controls a first and a second memory 208 and 224, see FIG. 2, to be described later. More specifically, the controller 34 generates address signals designating addresses where the image data should be stored and a write and a read signal for respectively controlling the write-in and read-out of the image data. The address signals and write and read signals are delivered to the first and second image memories 208 and 224 via a first and a second image buses 200 and 210, see FIG. 2, respectively.

The controller 34 conditions the camera 10 for either one of the camera mode and movie mode in accordance with information input on an operation panel 50 by the user of the camera 10. At the same time, the controller 34 controls the zoom amount of the lens 14 while determining and recognizing the zoom position. In the illustrative embodiment, the controller 34 selects the movie mode when the operator pushes a release switch, accommodated in the operation panel 50 although not shown, by a first stroke or selects the camera mode when it is pushed by a second stroke. If desired, the zoom position of the lens 14 may be controlled by hand, in which case the controller 34 will also recognize the zoom position.

In the movie mode, the controller 34 feeds to the timing generator 32 a control signal indicative of thinning drive that causes the image sensor 16 to perform thinning read-out, so that the timing generator 32 generates timing signals matching with the above control signal. Further, on detecting the second stroke of the release switch indicative of the camera mode, the controller 34 delivers to the timing generator 32 a drive signal designating full-pixel read drive that causes all composite pixels to be read out from the image sensor 16 in two fields.

Further, in the illustrative embodiment, to reduce the influence of shading ascribable to the conditions of a field to be picked up, the controller 34 controls the processing of image data in accordance with the color temperature and luminance of a subject. For example, the controller 34 causes the digital signal processor 40 to lower the chroma of image signals output from the auxiliary photosensitive portions 410 of the image sensor 16.

Moreover, the controller 34 estimates the influence of shading on image signals, which are output from the auxiliary photosensitive portions 410, in accordance with the zoom position, iris configuration and other pickup conditions. The controller 34 then controls the digital signal processor 40 in such a manner as to lower the chroma of auxiliary pixels derived from the auxiliary photosensitive portions 410.

In addition, the controller 34 estimates, when estimating the influence of shading in accordance with the pickup conditions mentioned above, the saturation state of each color component included in the image signal. If saturation is expected to occur in any color component and make a dynamic range short, the controller 34 not only lowers chroma, but also switches a tonality correction table to thereby reduce color shift.

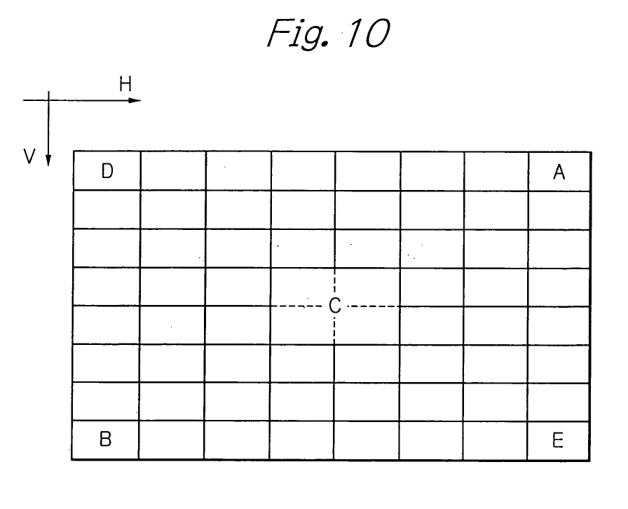

The controller 34 executes divisional photometry with a field to be picked up on the basis of an image represented by the image data that are input from the digital signal processor 40 and derived from the auxiliary photosensitive portions 410. More specifically, as shown in FIG. 10, assume the region of a frame divided into eight in each of the horizontal and vertical scanning directions, i.e. sixty-four blocks or pixel blocks in total. Then, the controller 34 measures a luminance level block by block, then calculates block-by-block photometric data necessary for an actual shot to follow, and then automatically controls exposure in accordance with the above photometric data in the movie mode or the camera mode.

In FIG. 10, assume that four nearby blocks at the center of the frame have a photometric value of C while the top right block and bottom left block where shading noticeably varies have photometric values of A and B, respectively. Further, assume that the sensitivity of each auxiliary photosensitive portion 410 implements a shot up to 400% for 100% sensitivity of each main photosensitive portion 412. Then, the controller 34 determines, color by color, whether or not the photometric values A and B each are greater or smaller than a preselected threshold TH by 2 EV (Exposure Value). With this decision, the controller 34 recognizes the saturation state of the color component of the individual auxiliary photosensitive portion 410 and then controls the digital signal processor 40 in such a manner as to reduce color shift.

The recorder 44 plays the role of a data holding section for recording coded, compressed or non-compressed image data in a data recording medium such that the image data can be read out, as needed. More specifically, the recorder 44 prepares an image file by adding various pickup data to the image data, attaches a particular file for distinction to the image, and then records the image file in the data recording medium. For the data recording medium, use may be made of a memory card including semiconductor storage devices or an optical disk, magnetic disk or similar large-capacity data storing medium. The recorder 44 may be configured to send the above image file to another data processing apparatus connected thereto by wireless or wire.

The monitor 46, including an LCD (Liquid Crystal Display) panel for displaying a picture represented by the image data for display output from the digital signal processor 42, displays the image data picked up or reproduced. Further, the monitor 46 is capable of generating an image signal for display and delivering it to an outside display 52 that may be connected to the monitor 46, as desired.

Reference will be made to FIG. 2 for describing the digital signal processor 40 in detail. As shown, the digital signal processor 200 includes a first image bus 200 and a second image bus 210. Connected to the first image bus 200 are a first WB (White Balance) gain circuit 202, a first γ (gamma) converter 204, an image adder 206, and a first image memory 208. Connected to the second image bus 210 are a second WB gain circuit 212, a second γ converter 214, the image adder 206, a synchronizer 216, a corrector 218, a compander 220, an image reducer 222, and a second image memory 224. Further, such constituents of the digital signal processor 40 all are connected to a control bus 230, which is, in turn, connected to the controller 34. The first and second buses 200 and 210 are connected to the controller 34, so that data are selectively written to or read out from the first and second memories 208 and 224 under memory control executed by the controller 34.

The first and second WB gain circuits 202 and 212 each control the white balance of the image signal applied to the input 42 in accordance with a control signal fed from the controller 34. More specifically, the first WB gain circuit 202 processes the auxiliary pixels derived from the auxiliary photosensitive portions 410 and outputs the processed pixels to the first image bus 200. Likewise, the second WB gain circuit 212 processes the main pixels derived from the main photosensitive portions 412 and outputs the processed pixels to the second image bus 210.

In the illustrative embodiment, the image data respectively derived from the auxiliary and main photosensitive portions 410 and 412 are respectively written to the image memories 208 and 224 after white balance processing, as stated above. Alternatively, such two kinds of image data may be alternately written to the storage areas of the image memories 208 and 224 being switched and then subject to white balance processing.

The first and second γ converters 204 and 214 respectively convert the image data thus stored in the image memories 208 and 224 by referencing lookup tables, i.e. executes gamma correction with the image data. More specifically, the γ correctors 204 and 214 each select, under the control of the controller 34, a lookup table having an image data correction characteristic that reduces saturation particular to each color component, thereby correcting tonality.

The image data output from the γ correctors 204 and 214 are input to the image adder 206 via the image buses 200 and 210, respectively, and added on a composite pixel basis thereby. More specifically, the image adder 206 adds the pixel values of the main and auxiliary pixels constituting a single composite pixel in combination to thereby broaden the dynamic range of the pixel values. In the camera mode, for example, the image adder 206 generates image data having a broad dynamic range and outputs the image data to the bus 210, so that the image data are written to the image memory 224 under the control of the controller 34. At this instant, the controller 34 may write the above image data in the storage area of the first memory 208 as well, if necessary.

The synchronizer 216 interpolates pixels and colors in the image data added by the image adder 206 in, e.g. the camera mode for thereby calculating pixel values of the R, G and B components at the individual composite pixel positions. In addition, the synchronizer 216 generates virtual pixels to be located between nearby composite pixels by pixel interpolation.

In the movie mode, the fist WB gain circuit 202, first γ corrector 204 and pixel adder 206, dealing with the auxiliary pixels, are maintained inoperative. Instead, the processing executed by the second WB gain circuit 212 and second y corrector 214 is directly followed by the processing of the synchronizer 216.

More specifically, in the movie mode, the second WB gain circuit 212 adjusts the white balance of the pixel-by-pixel image data read out together from the image sensor 16 and then writes the resulting image data in the second memory 224. Subsequently, the second γ corrector 214 converts to image data thus stored in the second memory 224 as to tonality in accordance with a gamma table and again writes the so converted image data in the memory 224. Thereafter, the synchronizer 216 generates pixels for the image data stored in the memory 224, produces R, G and B pixel values at the individual pixel positions, and then writes the R, G and B pixel values in the memory 224. Further, the synchronizer 216 is capable of generating pixel values for virtual pixels under the control of the controller 34.

The corrector 218 calculates R, G and G pixel data with the image data stored in the image memory 224 and then generates luminance data Y and color difference data Cr and Cb. This processing will be referred to as color matrix processing hereinafter. The corrector 218 then executes gain adjustment and other correction processing with the color difference data Cr and Cb while executing contour enhancement with the luminance data Y. In the illustrative embodiment, the corrector 218 selects and executes, under the control of the controller 34, either one of a usual enhancement mode and a reduction mode that lowers the color difference level in order to reduce color shift. By the color matrix processing, the corrector 218 produces the luminance data Y and color difference data Cr and Cb from the R, G and B pixel data and coefficients.

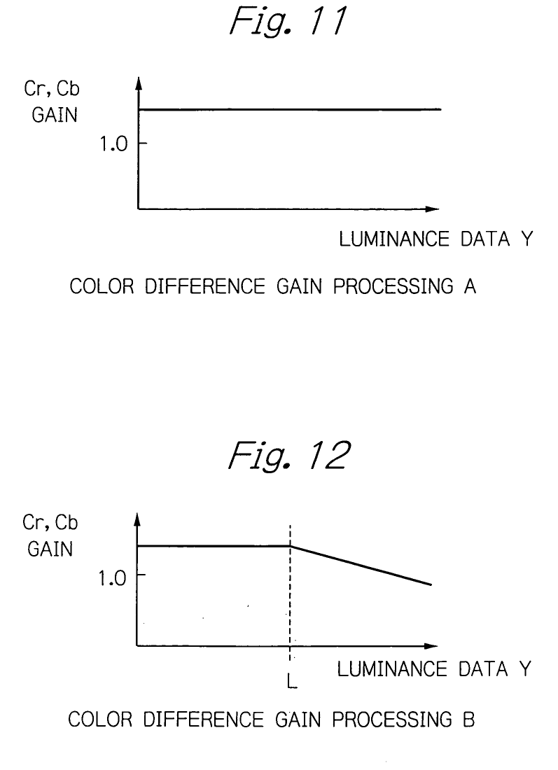

FIG. 11 demonstrates specific, color difference gain processing A that the corrector 218 executes in the usual enhancement mode. As shown, in the processing A, the corrector 218 amplifies the color difference data Cr and Cb with a preselected gain above 1, e.g. a gain of 1.5 without regard to the level of the luminance data Y associated with the color difference data Cr and Cb. FIG. 12 shows specific, color difference gain processing B that the corrector 218 executes in the reduction mode. As shown, in the processing B, the corrector 218 amplifies the color difference data Cr and Cb with the preselected gain up to the luminance data level of L, but lowers the above gain little by little as the luminance data exceeds the level L. The controller 34 determines which of the usual enhancement mode and reduction mode should be executed, and indicates the corrector 218 the mode selected.

Referring again to FIG. 2, the compander 220 codes the image data the image data fed thereto in the camera mode or the movie mode by executing compressing in accordance with, e.g. the JPEG (Joint Photographic coding Experts Group) or MPEG (Moving Picture coding Experts Group)-1 or -2 standards. The image data thus compressed are fed from the compander 220 to the recorder 44, FIG. 3, under the control of the controller 64. Alternatively, the compander 220 may simply hand over the input image data to the recorder 44 as raw data without compressing them. The compander 220 is capable of reading out the image data from the recorder 44 and expanding them under the control of the controller 34, as needed.

The image reducer 222 thins out, or reduces, the image data on a pixel basis in accordance with the size in which the image data should be displayed. More specifically, the image reducer 222 matches the size of the image data to the size of the LCD panel included in the monitor 46, FIG. 3, or that of the outside display 52 connected to the monitor 46. The image data thus reduced in size are output to the monitor 46.

The controller 34 estimates shading and color shift on the basis of the zoom position and other pickup conditions and then selects a particular signal processing method in accordance with luminance information derived from the field. The digital signal processor 40 so operates as to reduce the expected color shift under the control of the controller 34.

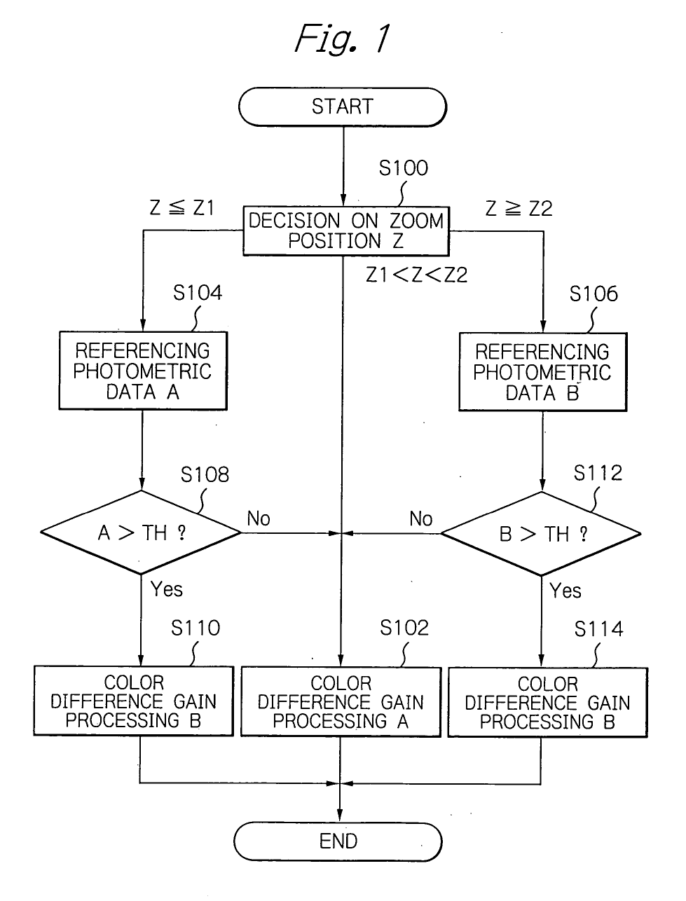

How the digital signal processor 40, particularly the corrector 218 thereof, selectively executes the color difference gain processing A or B will be described with reference to FIG. 1. As shown, the controller 34 determines the zoom position Z of the lens 14 at the time of pickup (step S100) If the zoom position Z is above a lower value Z1, but below a higher value Z2, then the controller 34 selects the color difference gain processing A (step S102).

On the other hand, the procedure advances to a step S104 if the zoom position Z is below or equal to Z1 or advances to a step S106 if it is above or equal to Z2.

In the step S104, the controller 34 references the photometric data A of the top right block A, FIG. 10, and determines whether or not the photometric data A is greater than a preselected threshold TH (step S104). If the answer of the step S104 is positive, Yes, then the controller 34 selects the color difference gain processing B (step S110). If the answer of the step S104 is negative, No, then the controller 34 again selects the color difference gain processing A (step S102).

In the step S106, the controller 34 references the photometric data B of the bottom left block B, FIG. 10, and determines whether or not the photometric data B is greater than the threshold TH (step S112). If the answer of the step S112 is Yes, then the controller 34 selects the color difference gain processing B (step S114). If the answer of the step S112 is No, then the controller 34 again selects the color difference gain processing A (step S102).

As stated above, in the illustrative embodiment, the controller 34 causes the corrector 218 to vary the color difference gain. Alternatively, the controller 34 may estimate shading on the basis of the zoom position of the lens 14 and photometric values and then switch the tonality conversion processing of the gamma converters 204 and 214. More specifically, when the controller 34 selects the color difference gain processing B (step S110 or 114, FIG. 1), it may cause the gamma converters 204 and 214 to use a lookup table that further compresses the high-luminance level portion.

The illustrative embodiment reduces shading, which is ascribable to the individual composite pixel consisting of the main and auxiliary photosensitive portions 412 and 410, FIG. 4, by using data derived from the photometric blocks A and B. However, the crux is that data derived from blocks greatly effected by shading be used. For example, as for the image sensor 800 having the configuration shown in FIG. 8, the photometric data D and E of the blocks D and E, FIG. 10, may be applied to the decision steps S108 and S112, FIG. 1.

In summary, in accordance with the present invention, in a solid-state image sensor of the type including a plurality of pixels each consisting of a main and an auxiliary photosensitive portion, it is possible to estimate color shift resulting from luminance shading ascribable to the exit pupil of a lens and then make the color shift inconspicuous by processing an image signal output from the image sensor. This is particularly advantageous when shading varies in accordance with the zoom position of a zoom lens or when use is made of interchangeable lenses.

The entire disclosure of Japanese patent application No. 2003-009778 filed on Jan. 17, 2003, including the specification, claims, accompanying drawings and abstract of the disclosure is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

What is claimed is:

1. A method of controlling a solid-state image pickup apparatus, comprising:
a preparing step of preparing a solid-state image pickup apparatus configured to process and output an image signal output from a solid-state image sensor that converts an optical image representative of a field and focused on said solid-state image sensor by a lens to the image signal, said solid-state image sensor including a plurality of composite pixels which are arranged in a photosensitive array and each of which consists of a main photosensitive cell and an auxiliary photosensitive cell different in sensitivity from each other and respectively formed by a main photosensitive portion and an auxiliary photosensitive portion, a plurality of microlenses respectively positioned on said plurality of composite pixels for focusing incident light, and a plurality of color filter segments respectively positioned on said plurality of composite pixels in a preselected pattern;
a photometry step of executing photometry with the field;
a signal processing step of processing the image signal; and
a control step of switching signal processing of said signal processing step in accordance with a result of photometry executed in said photometry step;
in said signal processing step, color difference gain processing for the image signal being switched in accordance with control of said control step to thereby lower a chroma of the image signal.

2. The method in accordance with claim 1, wherein said control step variably controls the signal processing for the image signal in accordance with a focal distance of the lens.

3. The method in accordance with claim 2, wherein said control step variably controls the signal processing for the image signal in accordance with a zoom position of the lens.

4. The method in accordance with claim 1, wherein in said signal processing step tonality correction processing for the image signal is switched in accordance with the control of said control step.

5. The method in accordance with claim 4, wherein in said signal processing step a gamma table to use is switched in accordance with the control of said control step.

6. The method in accordance with claim 1, wherein said control step determines shading on the basis of the result of photometry and switches the processing of said signal processing step in accordance with a result of determination.

7. The method in accordance with claim 6, wherein said photometry step executes divisional photometry with the field on the basis of the image signal output from the image sensor, and wherein said control step determines shading on the basis of a result of said divisional photometry.

8. A solid-state image pickup apparatus for processing and outputting an image signal output from a solid-state image sensor configured to convert an optical image representative of an objective field and focused on said solid-state image sensor by a lens to said image signal, said solid-state image sensor including a plurality of composite pixels which are arranged in a photosensitive array and each of which consists of a main photosensitive cell and an auxiliary photosensitive cell different in sensitivity from each other and respectively formed by a main photosensitive portion and an auxiliary photosensitive portion, a plurality of microlenses respectively positioned on said plurality of composite pixels for focusing incident light, and a plurality of color filter segments respectively positioned on said plurality of composite pixels in a preselected pattern, said apparatus comprising:
a signal processor configured to process the image signal; and
a controller configured to switch signal processing of said signal processor in accordance with a result of photometry;
wherein said controller includes a photometry circuit configured to executed photometry with the field, said signal processor switching, under control of said controller, color difference gain processing for the image signal to thereby lower a chroma of said image signal.

9. The apparatus in accordance with claim 8, wherein said controller variably controls the signal processing for the image signal in accordance with a focal distance of the lens.

10. The apparatus in accordance with claim 9, wherein said controller variably controls the signal processing for the image signal in accordance with a zoom position of the lens.

11. The apparatus in accordance with claim 8, wherein said signal processor switches tonality correction processing for the image signal under the control of said controller.

12. The apparatus in accordance with claim 11, wherein said signal processor switches a gamma table to use under the control of said controller.

13. The apparatus in accordance with claim 8, wherein said controller determines shading on the basis of the result of photometry and switches the processing of said signal processor in accordance with a result of determination.

14. The apparatus in accordance with claim 13, wherein said photometry circuit executes divisional photometry with the field on the basis of the image signal output from the image sensor, said controller determining shading on the basis of a result of said divisional photometry.
